(19) United States
(12) Patent Application Publication
(10) Pub. No.: US 2003/0130830 A1
(43) Pub. Date: Jul. 10, 2003

(54) Automated approach for measuring signaling setup, hold and jitter

(75) Inventors: William B. Gist, Chelmsford, MA (US); Robert D. Cole, Malden, MA (US)

Correspondence Address: LAHIVE & COCKFIELD, 28 STATE STREET, BOSTON, MA, 02109, US

(73) Assignee: Sun Microsystems, Inc., Palo Alto, CA (US)

(21) Appl. No.: 10/040,709

(22) Filed: Jan. 7, 2002

(51) Int. Cl. G06F 17/50

(52) U.S. Cl. 703/19

(57) ABSTRACT

An analysis facility analyzes simulation output resulting from a simulator of an electrical component, such as a microprocessor. The simulation output contains waveform representations of at least one data signal and a clock signal. The analysis facility analyzes the waveform representations and the simulation output to produce a report regarding signaling performance metrics, such as data jitter, setup times and hold times. The analysis facility may be customized by the user specifying parameters. For example, the user may specify what portion of the time frame for which simulation results produced are to be analyzed by the analysis facility. The user may also specify parameters such as cycle time and reference voltage values, including an indeterminate state region.

### TECHNICAL FIELD

The present invention relates generally to signaling performance analysis for electrical components and more particularly to an automated approach for measuring setup, hold and jitter for simulated electrical component designs.

### BACKGROUND OF THE INVENTION

During the design of electrical components, such as microprocessors, designers generally wish to examine the signaling that results from the design. It is useful for the designers to compare the timing of respective signals to ensure that the timing is acceptable and does not cause unanticipated problems. The signaling produced by a given electrical component design may be simulated using commercially available simulation packages. An example of such a simulation product is the SprecctraQuest package sold by Cadence Design Systems, Inc. of Portland, Oreg. The commercially available simulation packages generally produce simulation results in the form of representations of respective signals employed in the simulation. A signal typically is represented by a series of magnitude and time values.

In order to analyze the simulation results in conventional systems, a designer has two options. The first option is to manually analyze the simulation results to reach conclusions regarding signaling performance. The second option is to write a customized script that is executed by a computer to analyze a particular set of simulation results. Unfortunately, both of these options are cumbersome, time-consuming and prone to human error.

### SUMMARY OF THE INVENTION

The present invention addresses the above-described limitations of conventional approaches to analyzing simulation results of electrical components to perform signaling performance analysis. In particular, the present invention provides an automated approach to analyzing signaling performance for signals produced by a simulation or captured hardware results. The automated approach may generate information regarding performance metrics, including but not limited to data jitter, clock jitter, data setup and data hold times. Given that the approach is entirely automated, it is substantially less cumbersome and less prone to human error. The automated approach is generalizable in that it may be applied to a number of different signals and even to different simulation result outputs. The automated approach is customizable in that the designer may specify input parameters to customize the analysis to fit the needs of the designer.

In accordance with one aspect of the present invention, a method is practiced in an electronic device. In this method, simulation output is provided from a simulation of an electrical component. The simulation output contains information regarding a data signal and a clock signal. The data signal and the clock signal both may be single-ended or differential. An automated tool is provided for analyzing information regarding the data signal and the clock signal contained in the simulation output. User-specified parameters are received at the automated tool and applied to configure the analysis performed by the tool. The analysis of the simulation output is performed with the tool to produce the report of the analysis. The report may contain various types of measurement results including but not limited to data regarding data jitter, setup times and hold times for the data signal.

In accordance with another aspect of the present invention, the results of simulation of an electrical component are provided. The results contain waveform representations of a data signal and clock signal over a simulated time period. An automated analysis facility processes the results of the simulation to identify data jitter for the data signal.

### BRIEF DESCRIPTION OF THE DRAWINGS

FIG. 1 is a block diagram illustrating workflow in an illustrative embodiment of the present invention.

FIG. 2 is a block diagram of a computer system suitable for practicing the illustrative embodiment.

FIG. 3 is a flow chart that provides an overview of the steps that are performed in the illustrative embodiment.

FIG. 4 is a more detailed flow chart illustrating the steps that are performed for a user to enter parameters for the analysis facility in the illustrative embodiment.

FIG. 5 shows an example of a data jitter search window when a reference voltage window is defined.

FIG. 6 is a flow chart illustrating the steps that are performed by the analysis facility to process simulation output.

FIG. 7 illustrates a portion of a data signal for a data jitter hold_hi event with single-ended data.

FIG. 8 illustrates a portion of a data signal for a data jitter hold_lo event with single-ended data.

FIG. 9 illustrates a portion of a data signal for a data jitter setup_hi event with single-ended data.

FIG. 10 illustrates a portion of a data signal for a data jitter setup_lo event with single-ended data.

FIG. 11A shows an example of a data jitter search window when differential signaling is used.

FIG. 11B shows an example of a data jitter search window when differential signaling is used along with an uncertainty window.

FIG. 12A shows an example of a portion of a data signal for a data jitter hold_hi event when differential signaling is used.

FIG. 12B shows an example of a portion of a data signal for a data jitter hold_lo event when differential signaling is used.

FIG. 12C shows an example of a portion of a data signal for a data jitter setup_hi event when differential signaling is used.

FIG. 12D shows an example of a portion of a data signal for a data jitter setup_lo event when differential signaling is used.

FIG. 13A shows an example of a portion of a data signal for a data jitter hold_hi event when an uncertainty window are used.

FIG. 13B shows an example of a portion of a data signal for a data jitter hold_lo event when an uncertainty window are used.

FIG. 13C shows an example of a portion of a data signal for a data jitter setup_hi event when an uncertainty window are used.

FIG. 13D shows an example of a portion of a data signal for a data jitter setup_lo event when an uncertainty window are used.

FIG. 14A shows an example of a positive setup_hi event with a single-ended data signal.

FIG. 14B shows an example of a negative hold_lo event and a negative setup_hi event with a single-ended data signal.

FIG. 14C shows an example of a positive hold_hi event with a single-ended data signal with a single-ended data signal.

FIG. 14D shows an example of a negative hold_hi event and a negative setup_lo event with a single-ended data signal.

FIG. 14E shows an example of a positive hold_lo event with a single-ended data signal.

FIG. 14F shows an example of a positive setup_lo event with a single-ended data signal.

### DETAILED DESCRIPTION

An illustrative embodiment of the present invention provides an analysis facility for analyzing simulation output produced by a simulator or captured electrical component results. The analysis facility automatically generates an analysis report holding information that is useful to a designer of an electrical component, such as a microprocessor. The analysis report may hold information, for example, regarding data jitter, clock jitter, setup times, and hold times for one or multiple signals. The analysis facility may be configured to adjust a number of input parameters that are specified by a user of the analysis facility.

With high speed signaling in electrical components, it has become increasingly popular to employ “clock forwarding.” With clock forwarding, a clock signal is sent along with data bits so that at the destination of the data may be appropriately synchronized with the clock. This approach is also known as “source synchronous.” One difficulty that sometimes arises when clock forwarding is employed is “data jitter.” Data jitter refers to how the timing of the data varies relative to the timing of the clock.

Other signaling characteristics that are useful to measure include “setup time” and “hold time.” Setup time refers to the time before a clock transition that the input data must be present and stable for proper operation of the component. Hold time refers to the time after the clock transition that the input data must be present and stable for proper operation of the component.

Signals may be single-ended (“non-differential”) or differential or may have a more complex encoding. With single-ended signals, the magnitude of the voltage of the signal relative to a common, explicit or implicit, switching reference voltage is used to determine whether the signal is in a logically high state (i.e., a logic one state) or a logically low state (i.e., a logic zero state). In contrast, with a differential signal, it is the magnitude at the difference between the voltage of the signal and its complement that determines the logic state for the signal. Differential signaling allows for quicker transitions between states and enables the voltage range between logic states to be of less magnitude than with single-ended signaling. More complex state encoding may include the use of multiple voltage levels (such as four or more levels) or timing encodings.

For illustrative purposes, the description below will refer to a bi-level signaling scheme. Voltage values of data nodes are either indeterminate (i.e., not in a region specifying a one values) or determinate (i.e., in a region specifying a zero value or in a region specifying a one value). However, the present invention may be practiced with signaling schemes with more than two determinate levels.

For purposes of the discussion below, a “clock event” refers to a transition of the clock signal from either a logically low state to a logically high state or a transition from a logically high state to a logically low state. Whether one of these transitions or both of these transitions constitute “clock events” is dependent upon the clocking mode employed in the simulation. For purposes of the discussion below, it is presumed that a clock event refers to an edge (whether a rising edge or a falling edge) of the clock signal.

A “transition event” refers to an event when a data signal makes a transition to/from a logically high state or to/from a logically low state. A “transition time” refers to a time during a simulation at which a transition event occurs.

A “data node” refers to a point in the electrical circuit that is being monitored. The analysis facility of the illustrative embodiment may be applied to multiple data nodes or even to just a single data node.

As will be described in more detail below, the illustrative embodiment of the present invention defines a search window that surrounds each clock event for each data node in the simulation results. Transition events are identified within the search window and recorded. These transition events are used to analyze the simulation output results for data jitter, setup times and hold times. A report is then generated regarding the resulting analysis.

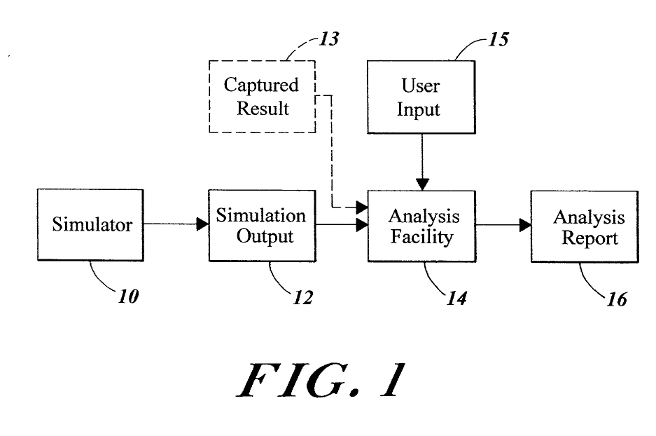

FIG. 1 is a block diagram illustrating high level interaction among components in the illustrative embodiment of the present invention. A simulator 10 simulates activities performed by one or more electrical components. The simulator 10 may be any of a number of different commercially available simulators, including the SpecctraQuest simulator referenced above. The simulator 10 may also be a custom-built simulator. The simulator 10 produces simulation output 12. The simulation output 12 includes data (such as waveform representations) regarding various signals from the one or more components. The simulation output 12 is analyzed by the analysis facility 14. Alternatively, the analysis facility 14 may analyze captured results 13 from an electrical component. The analysis facility 14 is, in the illustrative embodiment, a software tool for analyzing the simulation output 12 or captured results 13. Those skilled in the art will appreciate that the analysis facility 14 need not be implemented as a software facility but may be implemented in firmware, in hardware or in a software/hardware hybrid. The analysis facility 14 receives user input 15 that the analysis facility employs to configure the analysis. The operation of the analysis facility 14 and the nature of the user input 15 will be described in more detail below. The results of the analysis are incorporated into an analysis report 16. The analysis report 16 may be printed, shown on a video display or even stored for subsequent viewing. In the illustrative embodiment, the analysis report 16 holds information regarding data jitter, clock jitter, setup times, and hold times in addition to other information. Nevertheless, those skilled in the art will appreciate that the present invention may also be applied to generate other types of analysis information that may be contained within the analysis report 16. Moreover, those skilled in the art will appreciate that the analysis facility 14 need not produce a formal report per se, but rather may produce results that are stored in other formats or that trigger programmatic activity.

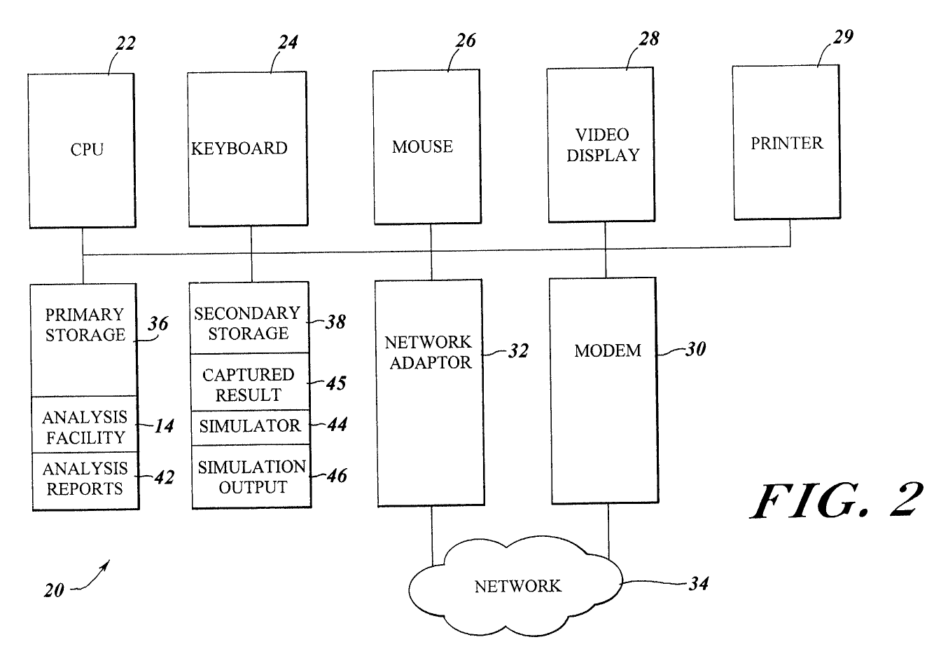

The analysis facility 14 may execute on a computer system or other suitable type of intelligent electronic device. FIG. 2 shows a block diagram of one suitable computer system 20 for practicing the illustrative embodiment. Those skilled in the art will appreciate that the analysis facility may run on a number of different types of electronic devices, including but not limited to a personal computer, a laptop computer, a workstation, a server computer system, a mainframe computer system, a mini-computer system or a personal digital assistant (PDA).

The computer system 20 of FIG. 2 includes a central processing unit (CPU) 22 for overseeing activities within the computer system. The analysis facility 14 runs on the CPU 22. The computer system 20 may include a keyboard 24, a mouse 26, a video display 28, a printer 29 and/or other varieties of peripheral devices. The computer system 20 may also include a modem 30 and a network adapter 32 for communicating with a network 34 to gain access to remote resources.

The computer system 20 includes a primary storage 36 and secondary storage 38. The primary storage 36 and the secondary storage 38 may include magnetic or optical storage media, including removable storage media. The primary storage 36 may include a copy of analysis facility 14 and analysis reports 42. The secondary storage 38 may include a copy of a simulator 44 and simulation output 46 that is analyzed in an analysis facility. The simulator 44 and simulation output 46 may be resident in primary storage 36 during execution of the simulator 44.

Those skilled in the art will appreciate that the configuration of the computer system 20 shown in FIG. 2 is intended to be merely illustrative and not limiting of the present invention. The present invention may be practiced with computer systems that includes different components from those shown in FIG. 2. It should be appreciated the computer system 20 may be a multiprocessor system, and in some embodiments, the analysis facility may be executed a distributed fashion.

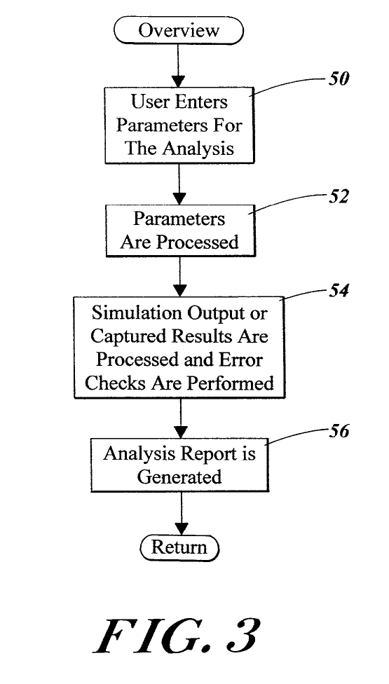

FIG. 3 is flow chart that provides a high level overview of the steps performed in the illustrative embodiment of the present invention in analyzing the simulation output 12 or the captured results 13 with the analysis facility 14 to produce an analysis report 16. Initially, the user enters data regarding user-specified parameters for the analysis (step 50 in FIG. 3).

The user input 15 may be provided by way of a user interface that prompts the user to provide the requested information. Alternatively, the user input may be incorporated into a file or other structure that is processed by the analysis facility 14. Still further, some of the information is gathered by way of user interface and some of the information is contained in the file that is processed by the analysis facility.

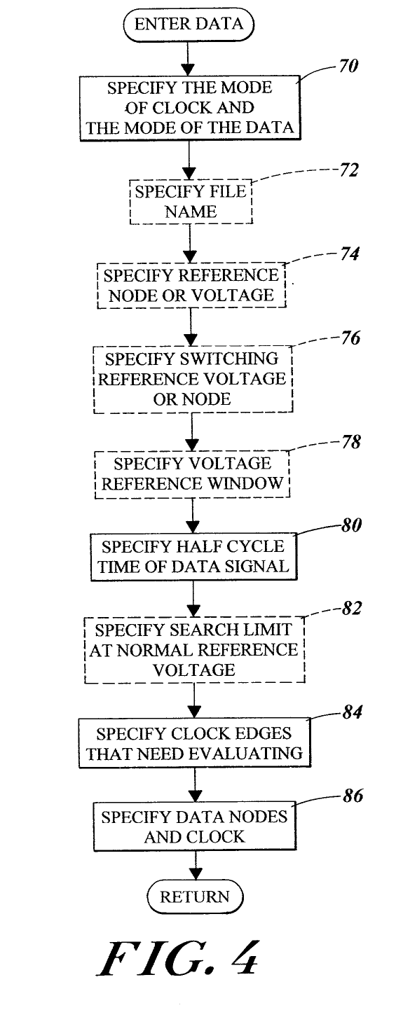

FIG. 4 is a flow chart illustrating in more detail the steps that are performed when the user enters data in step 50 in FIG. 3. Initially, the user specifies the mode of the clock and the mode of the data (step 70 in FIG. 4). In particular, the user specifies whether the data is a differential signal or a non-differential signal and whether the clock mode is a single clock rate where only a rising edge is evaluated or a double clock rate where both the rising edge and the falling edge are evaluated.

The user specifies a file name for the simulation output 12 or captured results 13 that is to be analyzed (step 72 in FIG. 4). This information allows the analysis facility to locate the data that is to be analyzed. In an alternate embodiment, the simulation output 12 or captured results 13 is passed directly to the analysis facility 14 for analysis. As such, the box 72 for this step is shown in FIG. 4 in phantom form to indicate that the step is optional.

The user may specify the name of a reference node (step 74 in FIG. 4). The reference node specifies the reference voltage in the electrical circuit being simulated. If the user does not specify the reference node name, the name defaults to a value of zero volts. The user alternatively may specify the magnitude of the reference voltage (step 76 in FIG. 4). The user may specify the magnitude of the switching reference voltage to be used relatively to the reference node or the voltage specified. The switching voltage reference is used for magnitude comparison with data signal(s) in determining signal state values.

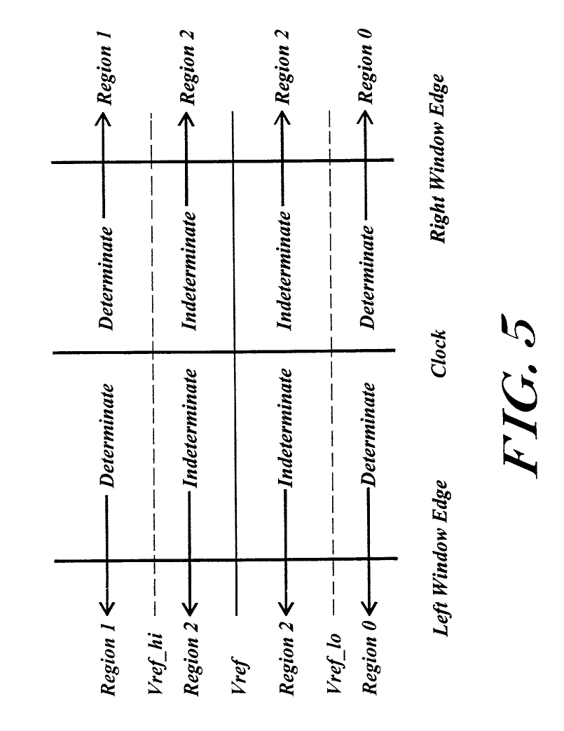

The user may specify a voltage reference window (step 78 in FIG. 4). If the voltage reference window is specified, a reference high voltage (Vref_hi) and a reference low voltage (Vref_lo) surrounding the switching reference voltage (Vref) are identified. FIG. 5 shows an example of a voltage window itemizing Vref_hi and Vref_lo.

The user specifies the half cycle time of the data signal (step 80 in FIG. 4). The cycle time is the nominal time interval used to transmit each data value or symbol.

The user specifies a search limit at the nominal reference voltage (step 82 in FIG. 4). In other words, the user specifies a left window edge and a right window edge for a search window that is used to locate events as will be described below. FIG. 5 depicts an example left window edge and a right window edge that are situated relative to a clock event.

The user specifies the clock edges that need evaluating so as to exclude particular clock events such as a first clocking event and a last event in the simulation results (step 84 in FIG. 4). Often times, early clock events in a simulation relate to data that should not be processed and may result in anomalies. As a result, this feature allows a user to avoid processing simulation results for such time periods.

Lastly, the user may specify the data nodes and the names of the clock signal and its complement clock_bar (step 86 in FIG. 4).

Once the user has entered the parameters for the analysis in step 50 of FIG. 3, the parameters are processed by the analysis facility 14 (step 52 in FIG. 3). Once the analysis facility 14 has been properly configured by the parameters, the simulation output 12 or captured results is processed by the analysis facility 14 and error checks are performed on the simulation output or captured results to ensure that there is no erroneous data (step 54 in FIG. 3). The analysis report 16 is then generated (step 56 in FIG. 3). The analysis report 16 may contain many types of data, as will be described in more detail below. The analysis report 16 may be output on the printer 29, displayed on the video display 28 or even stored in secondary storage 38 for subsequent review and use.

The discussion below will now focus on how the analysis facility 14 processes the simulation output 12 or captured results 13 to produce the analysis report 16. A good starting point for understanding the processing performed is to discuss the search window and the voltage reference window. FIG. 5 shows an example of a search window and voltage reference window. The voltage reference window is centered around a reference voltage Vref. There is a high reference voltage Vref_hi and a low reference voltage Vref_lo that are defined relative to a reference voltage Vref. A data signal is logically high when it exceeds Vref_hi and is logically low when it is below Vref_lo. The region between Vref_lo and Vref_hi is one in which the data signal is deemed indeterminate.

The search window extends ½ a cycle before a clock event (labeled “Clock” in FIG. 5) and ½ a cycle after the clock event. The borders of the search window are labeled “Left Window Edge” and “Right Window Edge” in FIG. 5. The user has the option of custom defining these window edges so that they are not exactly ½ a cycle in size. Instead, in such cases, the user provides a value for the half cycle time that differs from the actual half cycle time (see Step 80 in FIG. 4).

The illustrative embodiment gathers information regarding data jitter or data signal setup times and hold times. This is done by applying search algorithms and by searching for certain transition events in the simulation output 12 or captured results 13. A transition occurs when the data signal transitions from region 2 to region 1 or region 0. Or alternatively from region 0 or region 1 to region 2. The analysis facility 14 looks in the search window around each clock event to find to locate transitions for each data node. These transitions are recorded and then processed.

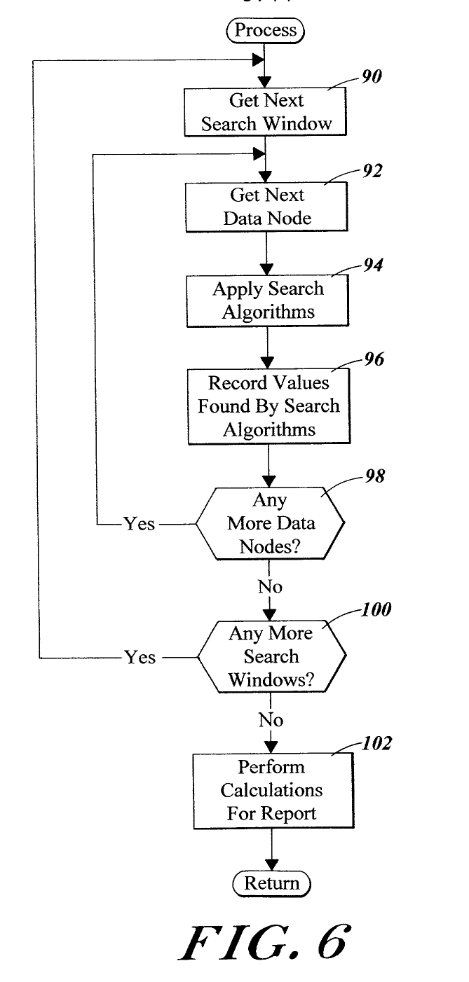

FIG. 6 provides an overview of the steps performed in processing the simulation output 12 or captured results with the analysis facility 14. A process begins by getting the next search window (step 90 in FIG. 6). Each of the data nodes is processed on a per search window basis until there are no more search windows remaining (see step 100 in FIG. 6). Hence, in step 92, the next data node to be processed is identified. The search algorithms are then applied to the search window for the given data node to identify transition events (step 94 in FIG. 6). Examples of transition events will be described in more detail below. The transition events and the times are recorded for subsequent processing (step 96 in FIG. 6). This process is repeated by checking if there are any more data nodes left (step 98 in FIG. 6). The process will also be repeated for any remaining search windows (see step 100 in FIG. 6). Once all of the search windows have been processed and all the data nodes have been processed, the analysis facility 14 performs any additional calculations needed to produce the analysis report 16 (step 102 in FIG. 6).

The discussion below will now focus on the particular search algorithms that are employed in step 94 of FIG. 6.

Data Jitter—Single Ended Data

The search algorithm for identifying data jitter values begins at the left window edge and the right window edge and proceeds inward until the clock event is reached. The search algorithm initially considers the left portion of the search window that is to be left of the clock event (i.e., precedes the clock in time) for possible data jitter hold events. The search algorithm then considers the right data jitter search window for possible data jitter setup events. The data jitter hold events come in two varieties: data jitter hold_i and data jitter hold_lo. A data jitter hold_hi event is characterized by the data signal falling to a value less than Vref_hi to the left of the clock edge. Conversely, a data jitter hold_lo event is defined by data rising to a value equal to or greater than Vref_lo to the left of the clock edge.

The data jitter setup events also come in two varieties. The first of these varieties is the data jitter setup_hi event, which is characterized by data rising through Vref_hi to the right of the clock edge. Data jitter setup_lo is characterized by data falling through Vref_lo to the right of the clock edge.

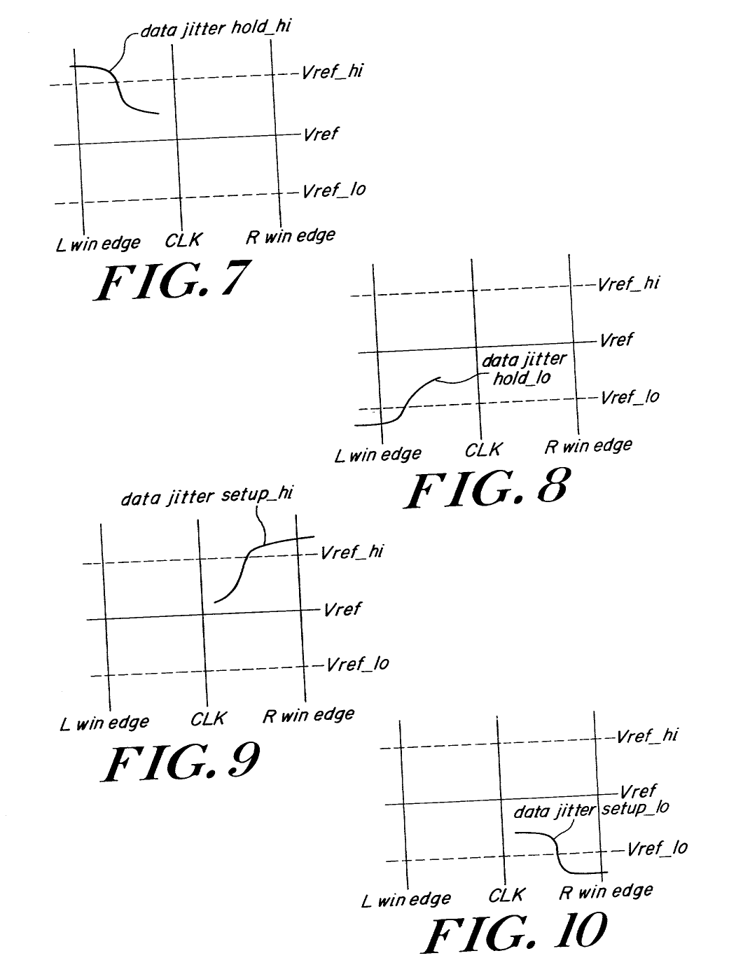

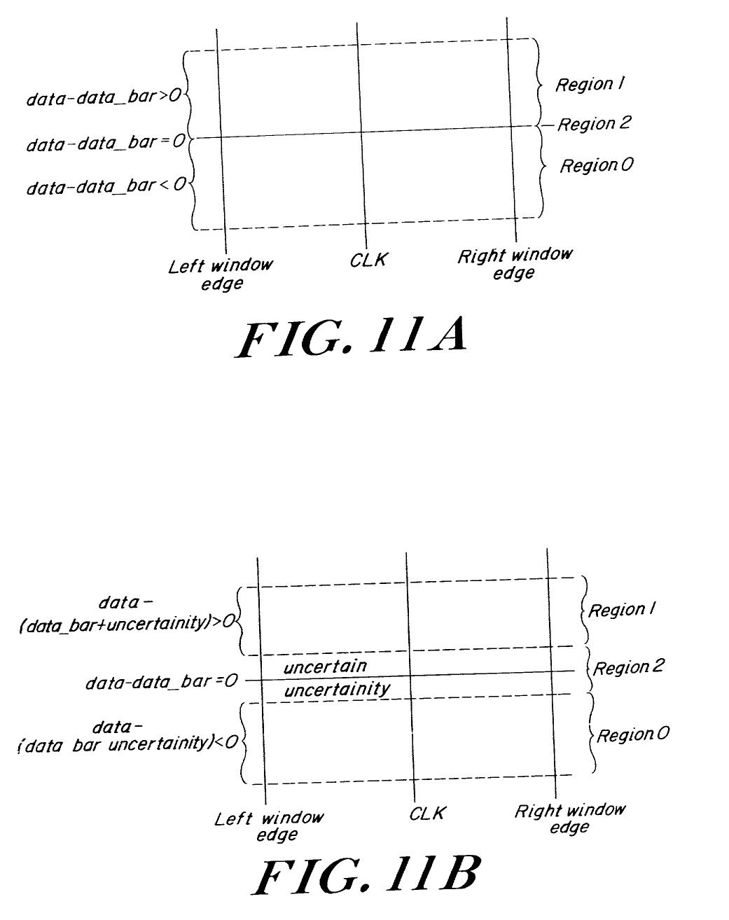

The analysis of the left search window halts if the data is indeterminate at the Left Window Edge. This is viewed as a timing failure. These types of data are viewed as timing failures. This is one way in which error checking is performed on the simulation output 12 or captured results 13. In such a case, no data jitter values are recorded but a message is generated to indicate that a timing failure has occurred. If the data is determinate at the left window edge but no transition is found searching forward to the clock, nothing is recorded. If, however, the data is in a determinate region on the left search window edge and a transition is found searching right to the clock edge, an event will be recorded depending upon the nature of the transition. If the data is in region 1 at the left search window and falls to a value equal to or less than Vref_hi, the transition is recorded as a data jitter hold_hi event (see FIG. 7) and the search of the left window stops after finding such an event. If, on the other hand, the data is in region 0 at the left search window edge and rises to a value equal to or greater than Vref_lo, the transition is recorded as a data jitter hold_lo event (see FIG. 8).

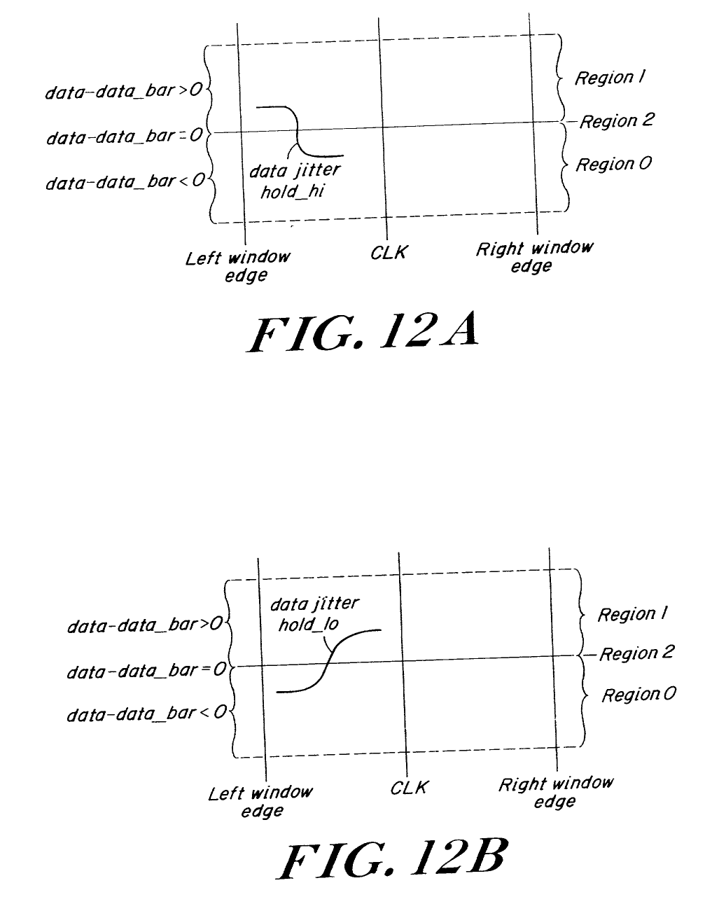

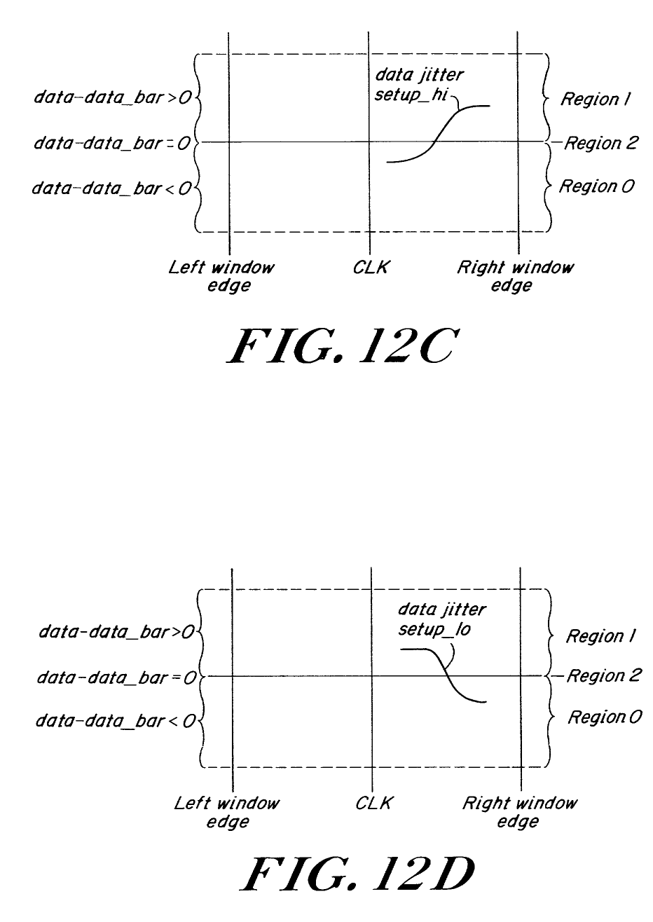

As was mentioned above, searching also occurs for the right clock window that extends from the right window edge back to the clock event. If data is indeterminate at the right window edge, no data jitter values are recorded but a message is generated to indicate that a timing failure has occurred. If the data is valid at the right window edge but no transition is found searching back to the clock, nothing is recorded. Once again, this is part of the error checking that is performed. If the data is in region 1 at the right window edge and searching back to the clock, the data falls to a value equal to or less than Vref_hi, the transition event is recorded as a data jitter setup_hi event (see FIG. 9). Analogously, if the data is in region 0 at the right search window edge and searching backwards to the clock, the data rises to a value equal to or greater than Vref_lo, the transition is a data jitter setup_lo event and is reported accordingly.

Data Jitter—Differential Data

The situation is somewhat more complex when differential data is employed because both of the differential signals must be scrutinized. With differential data, the illustrative embodiment offers the option of defining an uncertainty measurement that constructs the window around data_bar. The upper and lower boundaries of this uncertainty window serve as benchmarks for the complementary data bit.

Where no uncertainty window is used. There are three regions of concern in the differential case:

| | |
|---|---|
| Region 1 | data > data_bar |
| Region 0 | data < data_bar |
| Region 2 | data = data_bar |

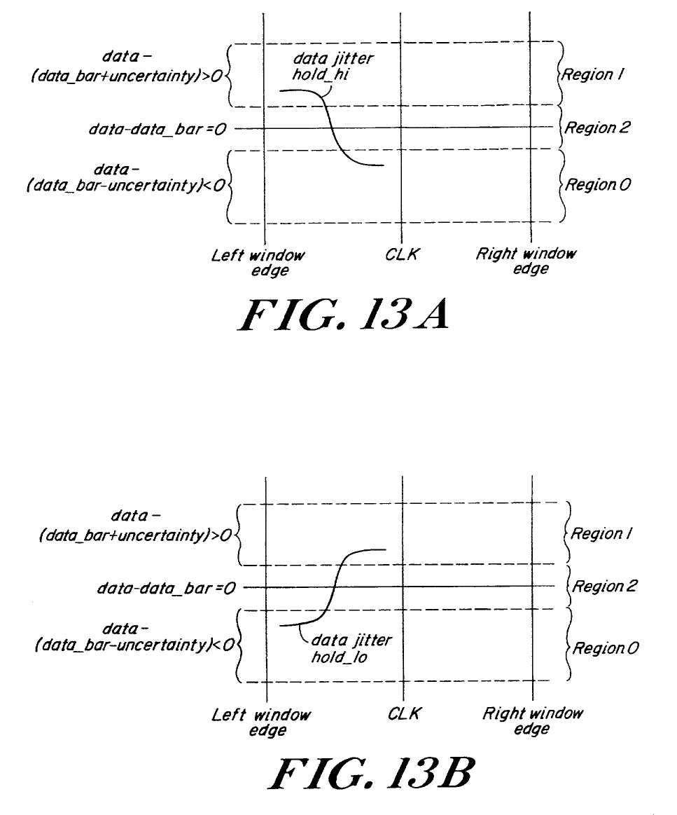

(See FIG. 11A).

In region 1, the data value is certain to have a logically high value and in region 0, the data value is certain to have a logically low value. In region 2, the value is uncertain.

The regions are defined somewhat differently when the uncertainty measurement is employed. In such a case, the regions are defined as follows:

| | |
|---|---|
| Region 1 | data > (data_bar + uncertainty) |
| Region 0 | data < (data_bar − uncertainty) |
| Region 2 | data ≦ (data_bar + uncertainty) and |
| | data ≧ (data_bar − uncertainty) |

(See FIG. 11B).

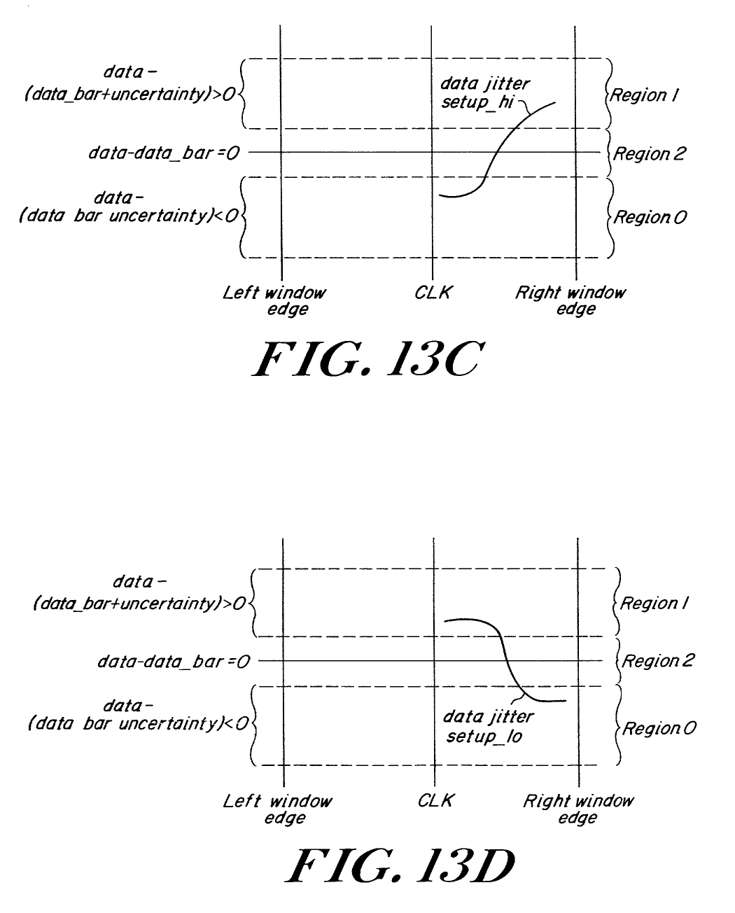

When no uncertainty window is used, a data jitter hold_hi event is defined by data being greater than data_bar at the left edge of the left search window, followed by data falling to be equal or less than data_bar to the left of the clock. Only the first such instance is recorded since a larger data jitter hold_hi value is produced if more than one instance occurs (see FIG. 12A). Similarly, a data jitter hold_lo event is defined by data being less than data_bar at the left edge of the left search window, followed by data rising to be equal or greater than data_bar to the left of the clock. On the first such instance is recorded (see FIG. 12A).

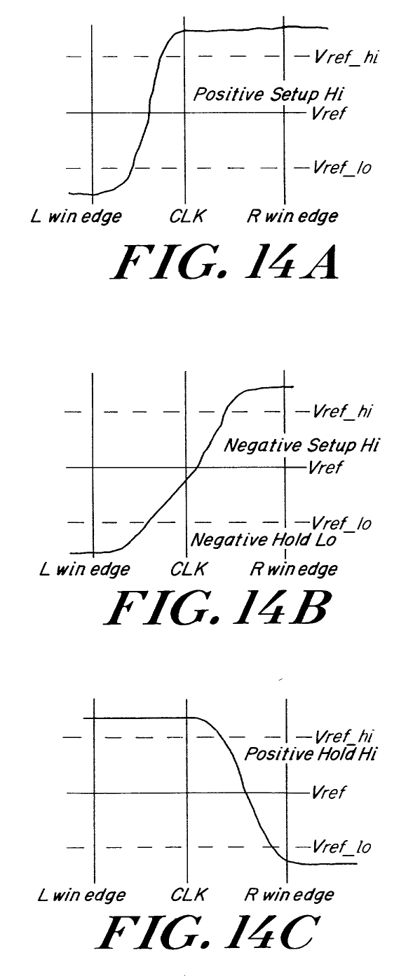

When an uncertainty window is employed, data jitter hold_hi is defined by data falling to a value equal to or less than data_bar plus the uncertainty measurement to the left of the clock edge (see FIG. 13A). Data jitter hold_lo is defined by data rising to a value equal to or greater than data_bar minus uncertainty measurement to the left of the clock edge (see FIG. 13B).

The data jitter setup events are defined as follows when no uncertainty window is employed. Specifically, a data jitter setup_hi event is characterized by data rising through data_bar to the right of the clock edge (see FIG. 12C). A data jitter setup_lo event is characterized by data falling through data_bar to the right of the clock edge (see FIG. 12D).

When an uncertainty window is employed, a data jitter setup_hi event is defined by data rising to a value greater than data_bar plus the uncertainty measurement to the right of the clock edge (see FIG. 13C). Data jitter setup_lo is defined by data falling to a value less than data_bar minus the uncertainty measurement to the right of the clock edge (see FIG. 13D). Similar to the cases with the data jitter hold_hi and the data jitter hold_lo events, only the first instances moving from the search window edges toward the clock are recorded.

The values found by the search windows are put into data structures, such as an array, where the values may be further processed to generate the analysis report 16. The analysis report 16 may contain information regarding all the data jitter setup and data jitter hold events or may instead contain information regarding just maximum values which may be set forth in the analysis report along with data node names and the simulation time of the events.

The analysis facility also determines the minimum setup and hold measurements for the entire simulation output 12. Minimum setup and hold measurements are those nearest the clock edge if they are positive setups or positive holds. Conversely, minimum setup and hold measurements are those farthest from the clock edge if they are negative setups or negative holds.

Setup and Hold—Single-Ended Data

The analysis facility 14 always identifies setup and hold events. The analysis facility 14 first determines the region the data is in at a window edge. The regions 0, 1 and 2 are defined as above for the single-ended data, if a voltage reference window is defined. If a voltage reference window is not defined, region 1 refers to data that is greater than Vref, region 0 refers to data that is less than Vref and region 2 refers to when data that equals Vref.

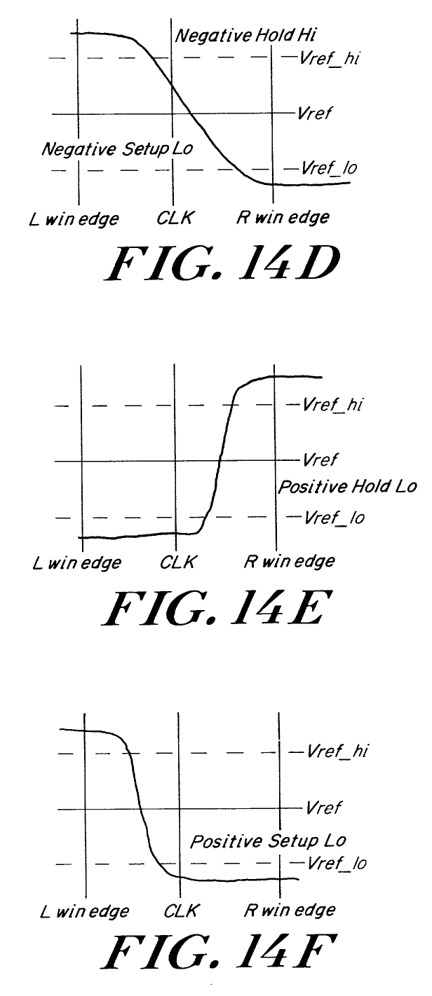

A setup_hi event is defined by the data signal rising above Vref_hi if a voltage window is defined. If a voltage window is not defined, the setup_hi event is defined by data rising above Vref. The setup_hi event is positive if the event occurs to the left of the clock edge (see FIG. 14A) and is a negative if the event occurs to the right of the clock edge (see FIG. 14B). This positive and negative naming convention is used for the other setup and hold events as well. The setup_lo event is defined by data falling below Vref_lo or Vref if no voltage reference window is defined. A hold_hi event is defined by data falling below Vref_hi or Vref. Lastly, a hold_lo event is defined by data rising above Vref_lo or Vref. No events are recorded if the data signal is in region 2 at the clock edge, and remains so while searching left until the window edge is reached.

The search in the left search window proceeds as follows. The search begins at the clock event edge and moves outward towards the left window's edge. If a positive setup event is found (such as a positive setup_hi (see FIG. 14A) or a positive setup_lo (see FIG. 14F)), the positive setup event is recorded along with the data node name and the simulation transition time. The search of the left search window then stops.

If a negative hold_hi event is found (see FIG. 14D), the search then jumps to the left window edge and proceeds inward towards the clock event until a negative hold_hi event is found. The resulting event is then recorded. This approach ensures that the hold_hi event that is recorded is that which is farthest from the clock edge, as the left search window may include multiple hold_hi events in some cases.

These methods locate the largest magnitude negative hold_hi event or the smallest magnitude positive hold_hi event if no negative hold_hi exists. The methods record at most one event for each data node for each clock cycle.

If a negative hold_lo event is found (see FIG. 14B), the search again jumps to the left window edge and starts towards the clock until a negative hold_lo event is found. This event is recorded.

The right search window is then processed. However, the right search window is processed beginning at the clock event and then proceeding to the right towards the right window edge. If a positive hold event is found (such as a positive hold_hi (see FIG. 14C) or a positive hold_lo (see FIG. 14E)), the event is recorded and the search of the right search window ends.

If a negative setup_hi event is found (see FIG. 14D), the search jumps to the right window edge and proceeds inward until a negative setup_hi event is found, which is then recorded. If a negative setup_lo event is found, the search jumps to the right window edge and proceeds inward until a negative setup_lo event is found. The resulting negative setup_lo event is recorded.

These methods locate the largest magnitude negative setup_hi event or the smallest magnitude positive setup_hi event if no negative setup_hi event exists. These methods ensure that at most one event for each data node in each clock cycle is recorded.

The events that are recorded are sorted to calculate the minimum setup_hi, setup_lo, hold_hi and hold_lo events for inclusion within the analysis report 16.

Setup and Hold—Differential Data

When differential data is employed in the regions 0, 1 and 2, an uncertainty window may be employed in determining the setup and hold values, as has been described above relative to the data jitter calculations for differential data.

When no uncertainty window is defined, a setup_hi event is defined by a data signal rising above data_bar. The event is positive if it occurs to the left of the clock edge and negative if it occurs to the right of the clock edge. A setup_lo event is defined by the data falling below data_bar. The event is positive if it occurs to the left of the clock edge and negative if it occurs to the right of the clock edge. A hold_hi event is defined by the data signal falling below data_bar. The value is positive if it occurs to the right of the clock edge and negative if it occurs to the left of the clock edge. A hold_lo event is defined by data rising above the data_bar. A value is positive if it occurs to the right of the clock edge and negative if it occurs to the left of the clock edge.

The events are somewhat differently defined if the uncertainty window is used. Specifically, the setup_hi event is defined by data rising above data_bar plus the uncertainty measurement. Similarly, the setup_lo event is defined by the data falling below data_bar minus the uncertainty measurement. The hold_hi event is defined by the data falling below data_bar plus the uncertainty measurement. The hold_lo event is defined by the data rising above data_bar minus the uncertainty event.

The processing described above relative to the single-ended data case is applicable for the differential data.

The analysis report 16 may take many forms. Set for below is one example of an analysis report:

Your simulation output had results for 21.000 ns

Number of clock edges in simulation output, excluding last edge=19

Analysis Range: Results below reflect analysis of clock edges 1 through 19

TABLE 1
Data Jitter

| | | | DJholdMAX | DjsetupMAX |
|---|---|---|---|---|
| | DJ_{—} | DJ_{—} | (ps) @ | (ps) @ |
| | check_hold | check_setup | Time (ns) | Time (ns) |
| | (ps) | (ps) | defining bit | Defining bit |
| High | None | none | 113.012 | 187.298 |
| | | | 6.050 | 6.350 |
| | | | d22 | d21 |
| | | | Q_data1 | Q_data0 |
| Low | None | None | 102.641 | 146.572 |
| | | | 6.050 | 18.308 |
| | | | d22 | d21 |
| | | | Q_data1 | Q_data0 |

TABLE 2
Data Setup and Hold

| | SetupMIN (ps) @ | HoldMIN (ps) @ |
|---|---|---|
| | Time (ns) | Time (ns) |
| High | 312.734 | 391.304 |
| | 6.350 | 6.050 |
| | d21 | d22 |
| | Q_data0 | Q_data1 |
| Low | 353.428 | 399.514 |
| | 18.308 | 18.058 |
| | d21 | d22 |
| | Q_data0 | Q_data1 |

TABLE 3
Clock Pulse Widths

| | |
|---|---|
| Minimum: | 0.963 ns, beginning @ 1.657 ns (sim. time) |
| Maximum: | 1.036 ns, beginning @ 2.619 ns (sim. time) |

These results are based on the following data input file information

| | |
|---|---|
| mode: | DDR_diff_clock_&_single_data |
| .tr0 file path & name: | /import/mm/localdirs/gist/sim/ |
| | chip2chip.tr0 |
| Signal ref. Node or vss nodename: | vsb2 |
| Switching reference (Vref) in volts: | 0.57 |
| Vref window (+/− volts): | 0.2 |
| Half-cycle Time (ps): | 500 |
| Delay Locked Loop delay (ps): | 500 |
| DJ search limit @ nominal Vref | 500 |
| (ps): | |
| begin_clock_edge_number: | 1 |
| end_clock_edge_number: | 99 |
| ck: | d24 |
| Ckbar: | d25 |
| data0 | d21 |
| data1 | d22 |
| data2 | d23 |

While the present invention has been described with reference to an illustrative embodiment thereof, those skilled in the art will appreciate that various changes in form and detail may be made without departing from the intended scope of the present invention as defined in the appended claims.

1. In an electronic device, a method, comprising the steps of:
providing simulation output from a simulation of an electrical component, said simulation output containing information regarding a data signal and a clock signal;
providing an automated tool for analyzing the information in the simulation output regarding the data signal and the clock signal and for producing a report of results of the analysis;
receiving user-specified parameters at the tool; and
applying the user-specified parameters to configure the analysis performed by the tool; and
performing the analysis of the simulation output with the tool to produce the report of the analysis.

2. The method of claim 1 further comprising the step of performing error checking on the simulation output to identify any errors in the simulation output.

3. The method of claim 1, wherein the report contains information regarding hold times of the data signal.

4. The method of claim 1, wherein the report contains information regarding setup times of the data signal.

5. The method of claim 1, wherein the report contains information regarding data jitter.

6. The method of claim 1, wherein the simulation output contains information regarding the data signal and the clock signal for a simulated time period and wherein the user-specified parameters include a specification of a portion of the simulated time period to which the analysis is to be applied.

7. The method of claim 1, wherein the user-specified parameters include a specification of a voltage reference window extending from a logically high reference voltage to a logically low reference voltage.

8. The method of claim 1, wherein the data signal is single-ended.

9. The method of claim 1, wherein the data signal is differential.

10. A storage medium for use with an electronic device, said medium holding instructions executable by the electronic device for performing a method, said method comprising the steps of:
receiving user-specified parameters regarding an analysis of simulation output from a simulation of an electrical component, said simulation output containing information regarding a data signal and a clock signal.
applying the user-specified parameters to configure the analysis; and
performing the analysis of the simulation output to produce a report of the analysis.

11. The storage medium of claim 10, wherein the method further comprises the step of performing error checking on the simulation output to identify errors in the simulation output.

12. The storage medium of claim 10, wherein the report contains information regarding hold times of the data signal.

13. The storage medium of claim 10, wherein the report contains information regarding setup times of the data signal.

14. The storage medium of claim 10, wherein the report contains information regarding data jitter.

15. The storage medium of claim 10, wherein the simulation output contains information regarding the data signal and the clock signal for a simulated time period and wherein the user-specified parameters include a specification of a portion of the simulated time period to which the analysis is to be applied.

16. The storage medium of claim 10, wherein the user-specified parameters include a specification of a voltage reference window extending from a logically high reference voltage to a logically low reference voltage.

17. The storage medium of claim 10, wherein the data signal is single-ended.

18. The storage medium of claim 10, wherein the data signal is differential.

19. In an electronic device, a method, comprising the steps of:
providing results of simulation of an electrical component wherein said results contain waveform representations of a data signal and a clock signal over a simulated time period; and
with an automated analysis facility, processing the results of the simulation to identify data jitter for the data signal.

20. The method of claim 19, wherein the method further comprises the step of producing a report containing information regarding the data jitter for the data signal.

21. The method of claim 19, wherein the step of processing the results processes the results for only a portion of the simulated time period.

22. A storage medium holding instructions of an automated analysis facility that are executable by an electronic device for performing a method, said method comprising the steps of:
providing results of simulation of an electrical component wherein said results contain waveform representations of a data signal and a clock signal over a simulated time period; and
with an automated analysis facility, processing the results of the simulation to identify data jitter for the data signal.
